(19) United States
(12) Patent Application Publication
(10) Pub. No.: US 2006/0204731 A1
(43) Pub. Date: Sep. 14, 2006

(54) Molded parts with mixed material surface areas and processes for their production

(76) Inventors: Vijay Wani, Pearland, TX (US); Rawad Aboughanem, Grand Blanc, MI (US); Eric Marchbanks, Linwood, MI (US); Michael E. Hus, Midland, MI (US); Curtis E. Peterson, Midland, MI (US); Thomas E. Van Conett, Saginaw, MI (US); Mary M. Hoagland, Midland, MI (US); Joseph A. Langmaid, Caro, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 11/358,587

(22) Filed: Feb. 21, 2006

Related U.S. Application Data
(63) Continuation-in-part of application No. 11/145,603, filed on Jun. 6, 2005.
Application No. 11/145,603 is a division of application No. 10/208,617, filed on Jul. 29, 2002, now Pat. No. 6,926,856.
(63) Continuation-in-part of application No. 10/767,011, filed on Jan. 29, 2004.
Application No. 10/767,011 is a continuation-in-part of application No. 10/208,617, filed on Jul. 29, 2002, now Pat. No. 6,926,856.
(60) Provisional application No. 60/655,194, filed on Feb. 22, 2005.

(51) Int. Cl. B32B 3/00

(52) U.S. Cl. 428/195.1

(57) ABSTRACT

The present invention provides thin injection molded plastic articles with an attractive, surface area of at least two different materials, such as leather, fabric, wood, metal or other semi-rigid surface material. These molded articles have desired combinations of thin dimensions, aesthetics and/or durability with the true feel of the real materials. The molded plastic articles thus have a plastic substrate component with a front decorative surface having at least two decorative surface areas of layers of different first and second materials having adjacent and connecting surface areas that are generally coplanar or continuous, including at the border line where the two surface layer materials meet. Relative to the front surface, at least a portion of the first material is located on top of and overlaps at least a portion of the second. In the process embodiment two surface material pieces are located in a mold cavity, the two materials together being located so as to each provide a surface area on the front side of the molded part. Optionally there is an adhesive and/or backing material on the back or non-decorative side of one or both surface material pieces. A molding plastic is injected into the mold that contacts and adheres to the back side of the surface material(s) and provides a molded on plastic substrate component. While the molding plastic is sufficiently fluid, pressure is applied to the cavity, preferably in an injection molding process, sufficient to compress and/or form the two different surface materials into a substantially coplanar or continuous surface and press the thicker overlapped area to a necessary depth into the plastic substrate component.

This invention relates to molded plastic parts having a plastic substrate with a surface layer that comprises different and directly adjacent and connecting surface areas of at least two different surface materials which can be selected from a broad range of flexible or semi-rigid surface materials such as fabrics, leathers, metal foil, wood veneer or similar semi-rigid surface material. This invention is also an efficient process for making these parts where the surface materials are uniformly conformed and adhered to the plastic substrate, and there is a very smooth and aesthetically pleasing border line or transition between the two materials. Parts are produced with good appearance, precise dimensions, thin part cross section and stable, secure material edges.

### BACKGROUND OF THE INVENTION

In the field of molded plastic parts, there are a number of processes for providing a surface layer or surface insert of a different material fabric, leather, metal, wood or paper, onto the surface of molded plastic parts using a molding process and pre-inserting the material piece into the mold. See for example US 2004-0018337(A1); US 2004-0018789(A1); and US 2004-0209032(A1). In continuing efforts to provide more distinctive, sleek and elegant electronic telecommunication and data devices such as cell phones and personal digital assistants, there has been great interest in using combinations of different decorative surface layers such as wood veneers, leather, fabric and metal and also in making the device as thin and compact as absolutely possible.

In US 2002/0142127 and WO 02/18478 molded plastic automotive trim parts are provided with adjacent surfaces of two different types of surface layer materials, referred to as appliques. The relatively thick edge of one layer material is abutted perpendicularly against or overlapped with the surface of the other material and the joined edge is then recessed into the bottom of a channel or groove that is molded deeply into the plastic part in comparison to the thicknesses of the two surface materials. In both cases the relatively thick plastic part has the two different surface materials meeting at a recessed groove or channel which hides and protects the actual connecting joint or seam of the two materials.

The necessity of very thin molded plastic parts for the thin and compact electronic telecommunication and data devices, however, precludes the use of this approach since the thin enclosure parts will not permit a relatively deep channel or groove that hides and protects the joined material seam. It can also be seen that many of the relatively rigid surface layer materials such as real wood veneers cannot readily be bent or curved at nearly a right angle as required to locate the seam in the bottom of a relatively deep groove.

### SUMMARY OF THE INVENTION

The present invention provides improved injection molded thin plastic articles with an attractive, surface area of at least two different materials, selected from a wide range of choices, such as real or synthetic leather, woven or non-woven fabric, wood, metal or other semi-rigid surface material. These molded articles have desired combinations of thin dimensions, aesthetics and/or durability with the true feel of the real materials.

According to the present invention, there is provided a process for preparing a molded plastic article having a plastic substrate component with a front decorative surface having at least two surface areas of layers of different first and second materials having adjacent and connecting surface areas that are generally coplanar or continuous, comprising the steps of: (a) locating two surface material pieces in a mold cavity such that from the back side, the first material piece is at least partially covered by the second material piece, the two materials together being located so as to each provide a surface area on the front side of the molded part. Optionally there is an adhesive and/or backing material on the back or non-decorative side of one or both surface material pieces.

This is followed by injecting in a molding step a molding plastic that contacts and adheres to the back side of the surface material(s) or their respective optional adhesive or backing and provides a molded on plastic substrate component and providing pressure while the molding plastic is sufficiently fluid, which pressure is sufficient to compress and/or form the two different surface materials into a substantially coplanar or continuous surface and press the thicker overlapped area to a necessary depth into the plastic substrate component. In a preferred embodiment, the molding step is in an injection molding process.

The first and second surface materials desirably used in this process are selected from the group consisting of natural or synthetic leather, natural or synthetic suede, wood, metal, stone, glass, ceramics, textile fabrics, plastic films, embroiderments, adhesive backed decals, paper and carbon fiber, with anodized aluminum being a preferred metal and a preferred first material. Preferred second surface materials include synthetic or natural leather and natural or synthetic suede such as microfiber synthetic suede.

With regard to the surface material pieces that are located in the mold cavity, desirably, the entire back of the first surface material piece is covered by the second surface material piece. Optionally, the first material is adhesively laminated to the second material prior to location in the mold and the two material pieces are a laminate that is located in the mold cavity.

In a further embodiment, the present invention is a molded plastic article having a plastic substrate component with a front decorative surface having at least two surface areas of layers of different first and second materials having adjacent and connecting surface areas that are generally coplanar or continuous, including at the border line where the two surface layer materials meet, and, relative to the front surface, at least a portion of the first material is located on top of and overlaps at least a portion of the second.

### BRIEF DESCRIPTION OF THE DRAWINGS

FIG. 1 is a cross section of the relative locations of the first and second materials prior to molding-on the plastic substrate.

FIG. 2 is a cross section of the surface materials and molded-on plastic substrate component in the mold after injection of the molding plastic and compression.

FIG. 3 is a cross section of a molded part according to the invention, not to scale, showing where the height differential at the border line between the two surface areas is evaluated.

FIG. 4 is a cross section showing location of a first surface material completely within and surrounded by the surface area of the second surface material.

### DETAILED DESCRIPTION

This invention provides improved injection molded articles with an attractive, durable surface area of two or more materials. A very wide range of materials can be used as the surface materials according to the present invention provided that their compressive and/or flexural properties are properly matched with the molding and compression conditions to obtain a sufficiently planar or continuous transition from one surface to the other. By “sufficiently planar or continuous” it is meant that along the border line on the final molded part surface where one material surface meets the other material surface, there is no recessed groove or channel molded into the plastic substrate deeper than about 0.6 mm, preferably no deeper than about 0.4 mm, and preferably no deeper than about 0.2 mm, that hides or protects the material seam.

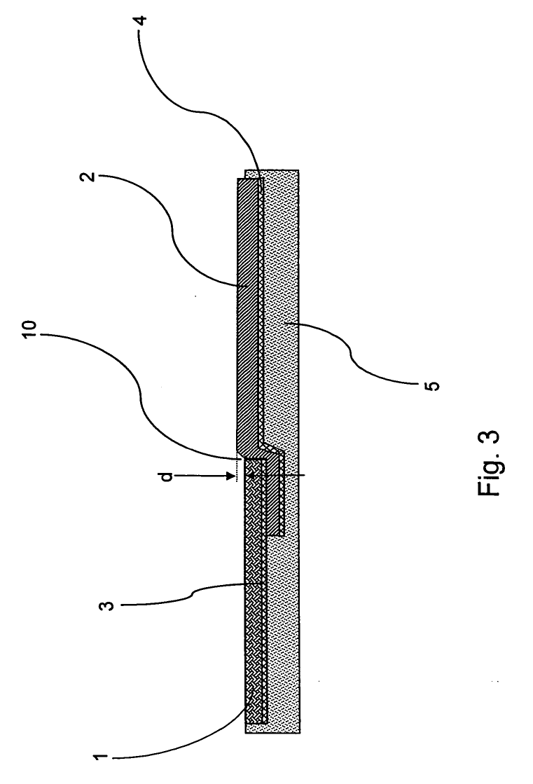

As the claimed product and process were being developed, it was very unexpected that the molding and compression of the two surface material layers formed a smooth surface with little or no gap (less than about 0.4 mm, preferably less than about 0.2 mm, more preferably less than about 0.1 mm) opening up at the line on surface between them after the molding and compression, as shown in FIG. 3. It was surprisingly found that the molded plastic substrate was effective in holding the relative positions of the insert materials after removal of the mold cavity and maintaining the smooth surface that was achieved during the compression during the molding process. Additionally, there was little if any separation at the boundary line between the two surface materials when the parts were removed from the mold.

By “sufficiently planar or continuous” it also means that there is little or no height differential between the material surfaces, preferably less than 0.6 mm, preferably less than 0.4 mm and most preferably less than 0.2 mm. The height differential is shown as “d” in FIG. 3. Although “d” is shown as the difference between a higher second material layer surface and a lower first material layer surface in FIG. 3, “d” also refers to the differential, if any, between a higher first material layer surface and a lower second material layer surface. A height differential, particularly where the first, top material is higher than the second material, especially if more than 1.0 mm or higher, will obviously be aesthetically unpleasing and provide a location where forces can act to peel off or delaminate the topmost material layer.

As known to practitioners in this area, the dimensions of the gaps, channels, height differentials, and surface material layers can be measured by optical microscopy or mechanical coordinate measuring equipment.

According to the present invention, the height differential “d” as shown in FIG. 3 was surprisingly small taking into consideration the fact that most of the surface materials tend to “rebound” somewhat after the compression step and would have been expected to provide surface height differentials corresponding generally to those at the point of overlap of two materials prior to molding.

A transition across a border line between two material layer surfaces can also be sufficiently continuous if the surface is not a flat, planar surface but is intended to be curving or spherical and, at the line where one material surface meets the other material surface, there is no gap, channel or height differential as described above.

In providing the desired thin parts according to the invention, the surface materials are preferably relatively thin. This can depend somewhat on the thickness of the plastic substrate component which can sometimes, to a limited degree, compensate for some of the thickness of the thicker materials, isolated thicker areas of some surface materials and/or the thicker area where the two materials overlap. In general, these surface materials range in thickness from about 0.1 mm up to about 4 or 6 mm. Preferably, to provide most efficient use of the materials and minimize part thickness, the thickness of materials is less than 3 mm, more preferably less than 2 mm, more preferably less than 1 mm and most preferably less than 0.8 mm. In order to provide sufficient strength for handling and durability, the thickness of the selected surface material should be at least 0.15 mm, preferably at least 0.2 mm, more preferably at least 0.3 mm and most preferably at least 0.5 mm.

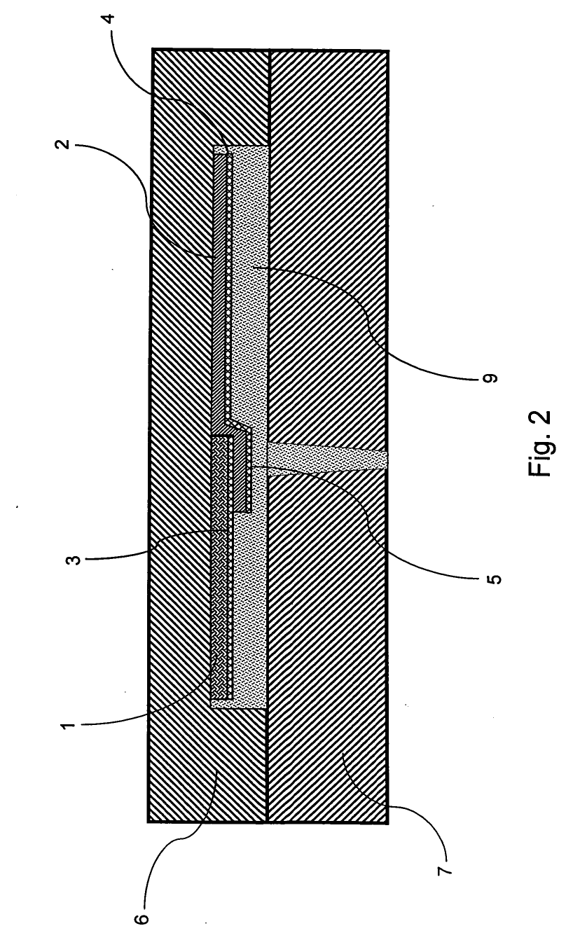

It is very important in the selection of materials and material combinations that their compressive and/or flexural properties at the thicknesses that are used, provide the desired continuous surface at the boundary line. This means obtaining under molding conditions (temperature and pressure), the proper degree of resistance to deformation of the first material and/or the ability to flex and/or deform the second material to the desired degree. As viewed from the back, the first material is at least partially overlapped by a second material when they are put into the mold. Upon the application of the compression the second material must be able to deform and/or bend to yield a distance of about the thickness of the first material layer, compressed or not and, as shown in FIG. 2, thereby cover most, if not all of the outside edge surface of the first surface material. At the same time, the first material, an edge of which creates the surface border between the two materials, must retain the desired edge distinctness when it is being compressed in the mold.

Typically, with material combinations where there are differences in their compressive and/or flexural properties, the first material which is partially covered or overlapped in the mold will be the stiffer or stronger material while the second material will be the softer or more flexible material. For example, rigid or semi-rigid materials such as metal, wood or thermoplastics would be suitable first materials to use with softer, more flexible second materials such as fabrics, including natural or synthetic leather. However, it should be noted that this is relative and wood or leather can be a more rigid first material in some combinations, with woven or non-woven textiles for example, or, if matched with a still more rigid material such as a metal, they can be the softer second material that is deformed by the metal first material upon sufficient compressive force. Even for the more rigid of the surface materials, there typically has to be a certain amount of flex or bend to accommodate the compressive force that will sometimes be applied non-uniformly in the compression step.

In general, therefore, proper matching of the second material with a selected first material and the molding conditions, primarily pressure, can be made by routine experimentation based on the known behaviors under molding condition. The key to obtaining optimized surfaces is use of a second material that can compress and/or bend sufficiently at the thickness used under the molding pressure. Although the first and second materials can be the same composition (for example, two natural or synthetic leather or suede materials of different colors), preferably the second material is measurably more flexible and easily conformable than the first, at the thicknesses used.

Therefore, taking into account the compressive property relationships that are discussed above and the molding conditions that will be discussed in more detail below, a very broad range of materials can be used according the present invention as either the first material, the second material, or, in some case as either one. It has been found that very suitable surface materials, especially for a first surface material, include fairly rigid surface materials which can be thin metal foil or sheet, wood veneer, or similar semi-rigid material that can be of natural or synthetic origin. This includes thin sheets or foils of various metals, thin veneers or sheets of wood or other similar rigid wood-based material such as paper, paperboard or converted paper products.

For example, the metal foil can be aluminum, copper, steel, stainless steel, zinc, magnesium, bronze, brass, titanium, gold, silver or other precious metals, including alloys of these, coated, plated or otherwise treated metal foils or sheets including Ni-coated steel, copper-plated steel, chrome-plated steel, tin-plated steel, and galvanized steel. In general, the suitable metals and metal alloys chosen have elastic modulus values ranging from 30 giga Pascals (Gpa) to 250 Gpa, densities ranging from 1.5 gram per cubic centimeter (gm/cc) to 22 gm/cc and Brinell Hardness numbers (HB) ranging from 15 to 500 kilograms per square millimeter (kg/mm²). Preferably the surface material is an aluminum alloy based on its combination of good forming properties and diversity of appearances and appearance treatments.

Wood-based materials include paper, paperboard or converted paper products including but not limited to 1.) cellulose wadding and webs of cellulose fibers, coated, impregnated, covered, surface colored, surface-decorated or printed, in rolls or sheet, 2.) multi-ply paper and paperboard, tracing papers and glassine and other glazed transparent or translucent papers, composite paper and paperboard, paper coated with kaolin or with other inorganic substances, 3.) corrugated paper and paperboard.

Wood includes veneer sheets which can be one or more layer and can include layers of different natural wood types provided the thickness does not exceed about 6 mm. The general types of wood that can be used include the many known varieties of natural woods that can be provided in the form of a thin sheet or veneer including cork, damoburl, white sycamore, mahogany, makore, rosewood, teak, padauk, ebony, birdseye maple, anigre, southern silky oak, bamboo, walnut, birch, spruce, silver heart, curly maple, hard maple and beech. Preferred wood surface materials include veneers of natural woods that have been treated and/or backed to make them more flexible and splinter-resistant and thus suited for use in a process of this type. Preferred wood surface materials include resin impregnated wood and wood veneers, where the resin makes the wood more soft and flexible for processing while the wood maintains the natural wood texture and smell and has improved crack resistance, durability, water resistance and UV resistance. In general, the densities of suitable woods (unseasoned) range from about 0.10 gm/cc to about 1.5 gm/cc. The values for modulus of rupture (static bending) range from about 0.0150 Gpa to about 0.500 Gpa and the values for flexural modulus (static bending) range from about 3 Gpa to about 30 Gpa.

In general, these semi-rigid surface materials range in thickness from about 0.01 mm to about 6.0 mm. Preferably, to provide most efficient use of the materials and minimize part thickness the thickness of materials is less than 2.0 mm, more preferably less than 1.0 mm, more preferably less than 0.5 mm and most preferably less than 0.3 mm. In order to provide sufficient strength for handling and durability, the thickness of the selected surface material should be at least 0.01 mm, preferably at least 0.1 mm, more preferably at least 0.3 mm and most preferably at least 0.6 mm.

A wide range of fabric materials can be used for a surface area of this invention. The suitable fabric materials include but are not limited to: natural and synthetic leathers (including both leathers and suedes) and any types of textiles or textile-like materials such as, woven, non-woven, and knit fabrics from natural or synthetic fibers/materials including coagulated polyurethane laminates, PVC and other rigid or flexible film or surface materials. The suitable “fabrics” may include laminates and structures combining two or more of these and the use of one or more of these with an adhered “backing material”.

Backing materials can be added to or may already be included on the surface materials to provide adhesion, stiffening and/or to prevent the molding plastic from being forced into or through a surface material or between two surface materials. Backing materials can include a wide range of natural or synthetic materials or textiles including woven, non-woven, and knit fabrics from natural or synthetic fibers/materials; films, foams or sheets of a plastic such as PC, PET, PBT, ABS, PA6,6, PP, HIPS, and blends of two or more of these materials.

In one embodiment of the present invention, a foam layer can advantageously be included as a backing material for fabric or an intermediate layer between a fabric surface and the substrate material. When using a compressible type of foam, this can provide or enhance the soft or cushioned feel of the fabric surface. This layer can be present on the fabric that is supplied for use or can be laminated to a fabric either prior to or during the molding/lamination of the substrate. In general, the foam can be open or closed cell and needs to be sufficiently heat resistant to retain its desired properties during the subsequent processing steps, for example not melting or collapsing to an unacceptable degree. Suitable foam densities are in the range of from about 5 to about 95 kilograms per cubic meter (kg/m³), preferably from about 20 to about 75 kg/m³, depending upon their layer thickness and degree of cushion or compression that is desired. The plastic material used in the foam can be a thermoset or thermoplastic and preferred foam plastic layers include a foamed thermoset polyurethane.

If it needs to be applied, a backing material can be bonded to a surface material or to a combination of surface materials by flame lamination, electromagnetic radiation bonding, or adhesive bonding, including thermally initiated adhesives such as Dow Adhesive Film or one of the adhesives selected from the list of adhesives mentioned below. As may be needed for facilitating fabrication of the part, a surface piece with optional adhesive and/or backing or a combination of surface pieces joined into a single piece by adhesive bonds and/or a backing layer can be cut, stamped out, shaped, formed and/or preformed by known techniques such as the known deep drawing processes for preparing pre-formed shapes to be inserted into the mold. Again, adhesives that would be suitable can be selected from the list below.

In the molding process where these surface materials are used, it is obviously of critical importance to achieve a strong and uniform bond between the injected plastic resin and the back side of surface materials that it comes into contact with, which can be an applied backing as mentioned above. It can also be important to achieve a strong and uniform bond between the back side of the first material and the surface of the second material which it overlaps in some cases, particularly for relatively flexible materials. If either of these bondings and adhesion are insufficient, the surface material may have visible bubbles or discontinuities and/or become noticeably delaminated. In many cases this will require an intermediate adhesive layer that is applied to the back of the surface material prior to the molding step.

The adhesive for the various bonds discussed above should be selected in terms of chemical nature and heat resistance to provide sufficient adhesion between the two materials and remain uniformly affixed and located across the entire surface area of the surface material during the molding step. Examples of suitable adhesives include these generic types of adhesive compounds:

1.) Reactive pre-polymer adhesive: Low to medium molecular weight prepolymers are used as adhesive materials. These adhesives are available in either one or two component systems. Upon cure, the prepolymers produce a chemically cross-linked thermosetting polymeric adhesive. Example: epoxy adhesives, polyurethane adhesives, silicone adhesives.

2.) Hot polymer melt adhesive: Many thermoplastic materials can be used as adhesives in their bulk/film form. The polymers are heated enough to wet the surfaces to be bonded, and re-solidify upon cooling. Polyolefin types are mainly mixtures of copolyolefins containing EVAs, acrylics and other polar groups as adhesion promoters, but they can also be mixed with resins and other components. Copolyamides, copolyester, thermoplastic polyurethanes are other kinds of hot polymer melt adhesives.

3.) Reactive monomers: Low molecular weight monomers having solvent like consistency are used as adhesives. The polymerization is initiated by light, heat and a lack of oxygen. Acrylics and cyanoacrylates are monomeric adhesive systems.

Adhesive films can be used which consist of one or more layers. If multilayered, coextruded films or films laminated by other known techniques can be employed with a combination of layers and selected surfaces to provide adhesion specifically for the surface material (such as wood or metal) on one side and for the plastic substrate or backing film (such as PC or ABS) on the other side.

It has been found, however, that when some adhesives for bonding to plastics are applied to the metal/wood and then directly exposed to high temperature, shear and pressure of injection molded plastic melt, they become ineffective to bond those materials uniformly to the plastic in a molding process due to either thermal degradation of adhesive, displacement of adhesive from surface by the high pressure flow of injected plastic, or due to the premature thermosetting of cross-linking adhesives prior to contact of the metal/wood to the plastic substrate. It has been found that the surface material can be used with a broader range of adhesives if the surface material, adhesive and a protective backing material (discussed further below) are initially bonded together eliminating direct exposure of adhesive to injection molded plastic melt.

In this fashion, when the back side of the surface material has an adhesive layer, a “backing” or protective film of some type can advantageously be used to protect the adhesive during any handling or transporting steps, to prevent otherwise tacky adhesives from sticking to anything undesired prior to the molding step and to protect the layer of adhesive and any heat sensitive surface materials during the molding step from temperature and shear forces from the flow of the molten injected plastic. Thermoplastic backing can be film or sheet of plastic such as PC, PET, ABS, PBT, PA66, PP, HIPS and blends of any two of these materials. The criteria for selection of an appropriate backing include the protection needed by the adhesive against the shear force and heat of the injection molded substrate as well as its compatibility and/or bonding to the injection molded substrate.

In general, the plastic substrate component (5) as shown in FIG. 2 can be prepared from a broad range of plastic materials including thermoset plastics such as polyurethane, epoxy or thermosetting silicone and thermoplastics such as polycarbonates (“PC”), ABS, polypropylene (“PP”), high impact polystyrene (“HIPS”), polyethylene (“PE”), polyester, polyacetyl, thermoplastic elastomers, thermoplastic polyurethanes (“TPU”), nylon, ionomer (for example, Surlyn), polyvinyl chloride (“PVC”) and including blends of two or more of these thermoplastics such as PC and ABS. These materials may contain pigments, additives and/or fillers that contribute any needed cost and/or performance features such as surface appearance, ignition resistance, modulus, toughness, EMI shielding and the like.

The actual adhesion of the adhesive and/or the backing material to the surface material(s) can be done prior to or during the molding of the plastic substrate component. If done prior, they can be applied sequentially or concurrently. If sequentially, the adhesive layer can be provided/applied by a sprayed-on layer, a laminated film or similar known coating or application techniques followed by application of the backing in the same fashion and under appropriate heating conditions. Preferably, the adhesive and backing layers are applied to the surface material concurrently, preferably as film materials, and bonded together by use of appropriate heat and pressure conditions. Heating steps could include flame lamination, electromagnetic radiation bonding, or hot roll lamination, flat bed lamination or the like.

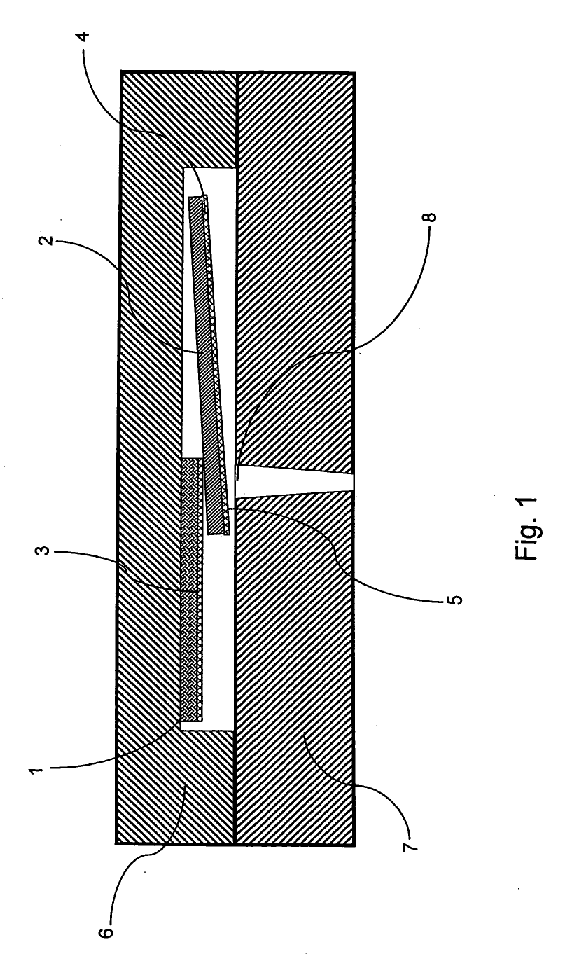

As shown in FIG. 1, the process according to the invention begins with placement of the surface material pieces into the mold cavity. As known to those practicing this area, there are many different types of molding equipment and configurations where the mold cavity can be vertical or be horizontal (where the cavity can be on the top or on the bottom). Similarly, where surface materials need to be located in the mold, there are known techniques including vacuum means and/or other registry means, such as pins and the like, that can be used to initially locate the surface material pieces in the proper location in the mold and hold them during the plastic injection step.

In FIG. 1 (not to scale) the first surface material (1) is initially located at the desired location in the mold cavity (6) with the decorative front side facing the mold surface to provide a surface area on the molded article and an optional layer of adhesive and/or backing (3) on the back side facing the side of the plastic injection gate (8) passing through the mold core (7). The piece of second surface material (2) having an optional adhesive and/or backing layer (4) on the back side is then located at the desired location. The second surface material covers and overlaps with the first surface material at the overlap area (5) and elsewhere has its decorative front side facing the cavity surface to provide a surface area on the molded article and the back side (with optional layer (4)) facing the plastic injection gate.

In FIG. 2 (not to scale) the molding plastic (9) has been injected to fill the mold, contact and cover the back sides of the surface materials, and form the plastic substrate component (5). There has been sufficient pressure applied to conform the decorative sides of the two surface material pieces into a generally smooth, planar surface against the mold cavity surface by flexing and compressing the second surface material against and around the first surface material.

In FIG. 3 (not to scale) a molded part is shown with the two surface materials providing two adjacent and connecting surface areas. In FIG. 3, the value of d, the height differential between the two surfaces (not to scale) is created by a slight rebound of the compressed second material after the pressure is released. According the invention, however, d is sufficiently small that the molded article has the appearance and feel of having a generally smooth and coplanar surface including at the boundary line between the two surface material areas (10).

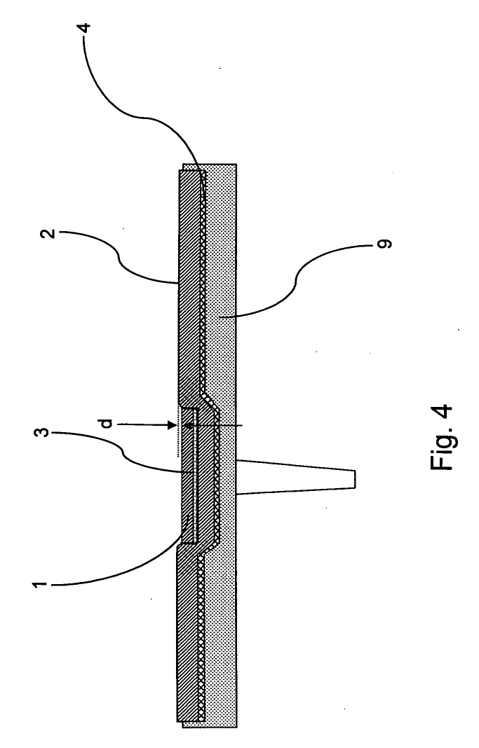

In one embodiment of the invention, as shown in FIG. 4, the first material surface can be located completely within the surface area of the second material (or, in an alternative embodiment, almost completely within) and either pre-bonded to the second material prior to location in the mold or separately located in the mold and bonded by the molding process. For example, a first material which is a metallic or thermoplastic logo plaque can be embedded into the leather or textile surface of a molded plastic article. The first surface material can also be a relatively thick embroidered design that can be either embroidered to a separate fabric patch or substrate or into the second material itself.

To obtain the desired overall shape and appearance of the molded plastic part, a certain amount of shaping, conforming or embossing can be done to at least one of the surface materials in the molding and/or compression step. The preferred surface materials, can be deformed further when plastic melt is injected into the mold and compression is applied. In this way, it is possible to impart certain complicated and/or detailed shapes and/or relief to one or more of the surface materials, such as embossing and sharp angles which could include application of a logo or other product marking. As needed to do this, the appropriate mold surface can be textured to any known surface finish that is desired for the surface material piece(s) (depending upon the type of surface material being used) or also for the appearance or texture of any exposed portions of any plastic substrate or edge coverings.

The plastic substrate component can be prepared by generally known molding techniques that are suited to provide the necessary plastic substrate or base part having the surface materials properly located and sufficiently adhered. A preferred molding technique is injection molding with the surface material pieces properly located and sufficiently fixed to the cavity or inner mold surface in an injection molding mold during the injection molding process. In the injection molding step molten plastic is injected into the mold, filling the mold and providing compression force against the back side of the surface materials, conforming the surface materials to the mold shape and simultaneously laminating or bonding the surface materials to the plastic and/or each other.

As discussed above, if needed, the surface materials that are exposed to the injected plastic may have an adhesive and/or a backing layer that protects the adhesive and facilitates the adhesion/lamination to the substrate component. Other suitable processes to form the substrate and/or in some cases assist in forming the substrate and/or attaching the surface materials include compression molding, radio frequency (RF) welding, sonic welding, thermoforming, injection compression molding, gas assist injection molding, structural foam injection molding, microcellular foam molding technology, laminar injection molding, water injection molding, external gas molding, shear controlled orientation molding, and gas counter pressure injection molding.

In the plastic injection step the plastic material (preferably molten plastic in an injection molding process) for the substrate is injected into the mold through an injection gate at a rate and pressure sufficient to fill the mold, completely cover the back (non-decorative) side of the exposed surface material piece, adhere the plastic to the back side of the surface material piece and preferably compress the surface materials against the mold surface and flow or deform as required by the extra thickness of the overlapped area to obtain a continuous surface at the border line of the two material surface areas. It may also be desirable to have the injected plastic material also cover the compressed thicknesses of the edges of the surface material(s) by not having them extend all the way to the edge of the mold cavity. As discussed above, injection molding is a preferred molding process, providing heating and compression conditions when the molten plastic is injected. In this fashion the injected molten plastic bonds strongly to the back of the exposed surface material(s) or to any optional backing or adhesive layers while the overlapping section of the surface materials is compressed and/or pressed into the plastic while the plastic is sufficiently fluid to conform or flow out from directly underneath the thicker overlapped area. In this way, the process according to the invention provides the desired final appearance or decorative surface that is generally smooth and continuous and preferably coplanar.

In the injection molding step or by using other pressure means, there typically needs to be sufficient force on the overlapped surface materials to compress or bend one or both and obtain a substantially continuous and smooth surface across the border line between two materials. In general, this can be done applying a pressure in the mold cavity of at least about 500 psi (3.44 mega Pascal (Mpa)) to the plastic substrate component and surface material layers. Preferably the applied force is sufficient to create a cavity pressure of at least about 2,000 (13.8 Mpa), more preferably at least about 5,000 psi (34.4 Mpa) and most preferably at least about 7,000 psi (48.2 Mpa). Cavity pressure can be measured by use of a pressure transducer located flush with the mold core or cavity inner wall, or by use of a pressure transducer located behind mold features (such as an ejector pin) directly in contact with the insert materials or plastic substrate component, or by calculation using the known pressure applied to the injection cylinder multiplied by the known intensifying ratio.

Thermosetting or thermosetable plastics can also be employed to similarly prepare the surface material-laminated plastic substrate component using known techniques for reaction injection molding or resin transfer molding.

Depending on the desired design of the final product, the selection of the surface materials and the shape and size of their relative surface areas, molded-on edge coverings and specific rigid backings can be utilized in obtaining the combination surfaces of the present invention. These molded-on edge coverings and/or rigid backing techniques are discussed in more detail in US 2004-0018337(A1); US 2004-0018789(A1); and US 2004-0209032(A1), which are hereby incorporated by reference herein.

It is helpful in obtaining good surface material appearance and adhesion and for the success of the subsequent edge-covering molding step that the precut surface materials be cut slightly smaller than the face of the cavity surface on which is located when the plastic resin is injected. In other words, the edges of the precut surface material do not extend to the side or edge walls of the cavity but instead leave a small gap that is then filled with molten, injected plastic that will form the substrate. When this gap is filled in, it will form a protective edge thickness covering. This injected plastic from the first step will then preferably cover at least a part of the thicknesses of the peripheral edges of the surface material. This gap between the edge of the mold cavity and the edge of the surface material is preferably in the range of from about 0.1 to about 2 millimeters (mm), preferably about 0.2 mm.

### EXAMPLES

In an example (Experiment 1) of the product and process according to the invention, a molded polycarbonate substrate is provided with a combination of metal and suede surface areas where the metal is the first material and is set as a stripe across the suede surface area. The metal in this example is anodized aluminum. The metal has a thickness of 0.006 inch (0.15 mm) and was laminated with a thermoplastic adhesive 2 layer film (“2 Layer”) having polyethylene (PE) on one side and polyamide (PA) on other side. This adhesive film has 10 grams (gm) of PE per square meter (/m²) and 40 gm PA /m², an overall density of 0.96 gm per cubic centimeter (gm/cm³), and a melting point range of 120 to 125 degree C. This film is laminated to the metal with the PE side against the metal using a flat bed laminator set at 135 degree C. and a lamination pressure of 80 pounds per square inch (psi) (0.55 Mpa). The metal is cut into desired surface area shape, a long stripe, and placed in the mold cavity with registration pins to hold the top material in registration with and over the cavity of the pre-forming mold.

The second material is a commercially available synthetic microfiber suede leather. The suede is provided with a first layer of an adhesive copolyamide film layer (“1 Layer”), having a density of 1.10 gm/cm and a weight of 35 gm copolyamide per m2 and a melting point range of 120 to 130 degree C. and on the adhesive layer surface a 0.007 inch (0.18 mm) ABS backing film. The suede laminate is prepared using the flat bed laminator as described above and cut into the desired surface area shape.

The first and second materials as described above are stacked together in a pre-forming mold using registration openings to provide proper location. The mold makes a complex concave shell shape for use in computer mouse molding. Heat is applied such that the backing film is heat softened and can be formed and the adhesive film between the layers softens and adheres them together. Once at appropriate temperature conditions (average top heater temperature at 150 degree C. and average bottom heaters temperature at 300 degree C.) the laminate is conformed to the shape of the preform mold by means of 40 bar (4 Mpa) applied pressure for 6 seconds and produces a multi-material laminate pre-form. There is little if any deformation of the second suede material by the first metal material at this point.

The laminate perform is than located in the injection molding tool cavity. Location features in the tool cavity are used to locate the insert properly inside the tool and the decorative or appearance surface is in contact with mold cavity during polymer injection and the ABS backing film is exposed to the injected molten plastic. The mold is than closed and polycarbonate (18 MFR) is injected in the cavity. During the injection the melt temperature was 550 degree F. (287° C.) and the injection pressure provided a cavity pressure of 22,000 psi (152 Mpa). The injection molding cycle produces a molded plastic article having a polycarbonate substrate component with a front decorative surface having a metal surface area set directly in a synthetic suede surface area with the connecting surface areas generally smooth and continuous, including at the transition line between the metal and the suede. This can be summarized as follows where the thicknesses of the first and second materials are measured in the overlap area before and after the molding and compression step.

| | | | Second | Plastic |
|---|---|---|---|---|
| Experiment 1 | | First Material | Material | Substrate |
| Type | | Anodized | Synthetic | Polycarbonate |
| | | Aluminum | Suede | |
| Thickness | (in) | 0.006 | 0.024 | n/a |
| | (mm) | 0.15 | 0.6 | |

(Before molding)

| | | | | |
|---|---|---|---|---|
| Cavity Pressure | (PSI) | 22,000 | | |
| | (MPa) | 152 | | |
| Thickness | (in) | 0.006 | 0.017 | 0.055 |
| | (mm) | 0.15 | 0.45 | 1.4 |

| | |
|---|---|
| (After molding) | |
| Height Differential at | −0.01 mm |
| Surface Border | (metal below |
| | suede level) |

In a similar fashion (Experiment 2 through 6), the following combinations of materials were used in an injection molding process to provide thin (1.8 mm) plastic protective PDA cover having a plastic substrate component with a front decorative surface having a combination of surface materials in connecting surface areas and having a generally smooth and continuous surface at the border line between the two materials.

In an example of the product and process according to the invention, these parts are prepared from a polycarbonate/ABS blend molding resin (PC/ABS) substrate and a combination of surface areas where the first material provides approximately a 63 mm by 38 mm surface area on the molded part and the second material provides a 63 mm by 76 mm surface area on the molded part. The first and second materials, backings and adhesives are summarized in the Table below.

Where indicated, the 1 Layer (copolyamide) and 2 Layer (PE/PA) adhesive films and the ABS backing film described above were used. The first material is laminated to the second material using and/or with any adhesive and backing films in a flatbed laminator and then cut to the desired shape including registration features. In the cut out laminate pieces that combine both surface materials, the second material entirely covers the back side of the first material (that is, the overlap area is the entire area of the first surface material) and extends beyond the first material in the area where the front side of second material will form a portion of the molded article surface. When looking at the back side of the insert laminate, the only visible material is the second surface material. When looking at the front or decorative side, the side that will face the mold cavity surface and form a surface area on the final part, the first material is about one third of the surface and the second material is about two thirds.

The laminate piece is then located in the injection molding tool cavity. Location features in the tool cavity are used to locate the insert properly inside the tool and the decorative aesthetic or appearance surface (with both surface materials exposed) is in contact with mold cavity and the ABS backing film on the back side of the second surface material is exposed to the injected molten plastic. The mold is then closed and polycarbonate/ABS blend resin is injected in the cavity. During the injection the melt temperature was 550 degree F. (287° C.) and the cavity pressure was 22,000 psi (152 Mpa). The injection molding cycle produces a molded plastic article having a polycarbonate/ABS substrate component with a front decorative surface having the two surface material areas with the connecting surface areas generally smooth and continuous, including at the transition line between the metal and the suede. These different examples are summarized as follows where the thicknesses of the first and second materials are measured in the overlap area before and after the molding and compression step. It should be noted that the thicker area of the two materials' overlap makes the plastic substrate component somewhat thinner in that specific area than in the rest of the molded article.

| | | Second | Plastic |
|---|---|---|---|
| Experiment 2 | First Material | Material | Substrate |
| Type | Perforated | Black | PC/ABS |
| | Stainless Steel | synthetic | |
| | | leather | |
| Adhesive/Backing | 2 Layer/none | 1 Layer/ABS | |
| Thickness (mm) | 0.20 | 0.76 | n/a |
| (Before molding) | | | |

| | | |
|---|---|---|
| Cavity Pressure | (PSI) | 15,000 |
| | (MPa) | 103 |

| | | | |
|---|---|---|---|
| Thickness (mm) | 0.20 | 0.47 | 1.13 |
| (After molding) | | | |
| Height Differential (mm) | −0.09 (metal | | |
| at Surface Border | below the leather) | | |

| | | | Plastic |
|---|---|---|---|
| Experiment 3 | First Material | Second Material | Substrate |
| Type | Wood Veneer | Red suede | PC/ABS |
| Adhesive/backing | 1 Layer/none | 1 layer/ABS | |
| Thickness (mm) | 0.30 | 0.60 | n/a |
| (Before molding) | | | |

| | | |
|---|---|---|
| Cavity Pressure | (PSI) | 15,000 |
| | (MPa) | 103 |

| | | | |
|---|---|---|---|
| Thickness (mm) | 0.30 | 0.28 | 1.22 |
| (After molding) | | | |
| Height Differential (mm) | −0.02 | | |
| at Surface Border | | | |

| | | Second | Plastic |
|---|---|---|---|
| Experiment 4 | First Material | Material | Substrate |
| Type | Synthetic | Suede fabric | PC/ABS |
| | Crocodile Leather | | |
| Adhesive/backing | 1 Layer/none | 1 layer/ABS | |
| Thickness (mm) | 0.70 | 0.60 | n/a |
| (Before molding) | | | |

| | | |
|---|---|---|
| Cavity Pressure | (PSI) | 15,000 |
| | (MPa) | 103 |

| | | | |
|---|---|---|---|
| Thickness (mm) | 0.70 | 0.45 | 0.65 |
| (After molding) | | | |
| Height Differential (mm) | 0.10 | | |
| at Surface Border | | | |

| | | | Plastic |
|---|---|---|---|
| Experiment 5 | First Material | Second Material | Substrate |
| Type | Polished | Red Suede fabric | PC/ABS |
| | Aluminum | | |
| Adhesive/Backing | 2 layer/none | 1 Layer/ABS | |
| Thickness (mm) | 0.20 | 0.60 | n/a |
| (Before molding) | | | |

| | | |
|---|---|---|
| Cavity Pressure | (PSI) | 15,000 |
| | (MPa) | 103 |

| | | |
|---|---|---|
| Thickness (mm) | 0.20 | 0.39 |
| (After molding) | | |
| Height Differential (mm) | −0.01 | |
| at Surface Border | | |

| | | | Plastic |
|---|---|---|---|
| Experiment 6 | First Material | Second Material | Substrate |
| Type | Polished | Wood Veneer | PC/ABS |
| | Aluminum | | |
| Adhesive/Backing | 2 layer/none | 1 Layer/ABS | |
| Thickness (mm) | 0.20 | 0.44 | n/a |
| (Before molding) | | | |

| | | |
|---|---|---|
| Cavity Pressure | (PSI) | 15,000 |
| | (MPa) | 103 |

| | | | |
|---|---|---|---|
| Thickness (mm) | 0.20 | 0.44 | 1.16 |
| (After molding) | | | |
| Height Differential (mm) | −0.03 | | |
| at Surface Border | | | |

In a similar fashion (Experiment 7), the first material is an embroidery design 2.1 mm thick that is stitched into the second material, a synthetic suede that is 0.6 mm thick. The significant projection of the embroidery from the surface of the suede at the border line and overall thickness of this layer is unacceptable for application to and use in typical electronic device enclosure applications such as cell phones or PDA's. According to the present invention, this first and second material combination was put into the mold cavity and, in an injection molding process, provided with a molded-on plastic substrate component and compressed to provide a thin (1.8 mm) plastic part having a front decorative surface with a combination of surface materials in connecting surface areas and having a generally smooth and continuous surface at the border line between the two materials. This is summarized in the Table below.

| | | | Plastic |
|---|---|---|---|
| Experiment 7 | First Material | Second Material | Substrate |
| Type | Embroidery | Suede Fabric | PC/ABS |
| | Design | | |
| Adhesive/Backing | n/a | 1 Layer/ABS | |
| Thickness (mm) | 2.10 | 0.60 | n/a |
| (Before molding) | | | |

| | | |
|---|---|---|
| Cavity Pressure | (PSI) | 15,000 |
| | (MPa) | 103 |

| | | | |
|---|---|---|---|
| Thickness (mm) | 1.1 | 0.45 | 0.25 |
| (After molding) | | | |
| Height Differential (mm) | 0.27 | | |
| at Surface Border | | | |

What is claimed is:

1. A process for preparing a molded plastic article having a plastic substrate component with a front decorative surface having at least two surface areas of layers of different first and second materials having adjacent and connecting surface areas that are generally coplanar or continuous, comprising the steps of: (a) locating two surface material pieces in a mold cavity such that from the back side, the first material piece is at least partially covered by the second material piece, the two materials together being located so as to each provide a surface area on the front side of the molded part and there optionally being adhesive and/or backing material(s) on the back or non-decorative side of one or both surface material pieces, (b) injecting in a molding step a molding plastic that contacts and adheres to the back side of the surface material(s) or their respective optional adhesive or backing and provides a molded on plastic substrate component and (c) providing pressure while the molding plastic is sufficiently fluid, which pressure is sufficient to compress and/or form the two different surface materials into a substantially coplanar or continuous surface and press the thicker overlapped area to a necessary depth into the plastic substrate component.

2. The process according to claim 1 wherein the molding process is an injection molding process.

3. The process according to claim 1 wherein the pressure in step (c ) provides a cavity pressure of at least about 7,000 psi (48.2 Mpa).

4. The process according to claim 1 wherein the first and second surface materials are selected from the group consisting of natural or synthetic leather, natural or synthetic suede, wood, metal, stone, glass, ceramics, textile fabrics, plastic films, embroiderments, and adhesive backed decals.

5. The process according to claim 1 wherein the first surface material is an anodized aluminum and the second surface material is synthetic leather.

6. The process according to claim 1 wherein the first surface material is an anodized aluminum and the second surface material is synthetic suede.

7. The process according to claim 1 where, in the mold cavity, the entire back of the first surface material piece is covered by the second surface material piece.

8. The process according to claim 1 wherein the first material is adhesively laminated to the second material prior to location in the mold and the two material pieces are a laminate that is located in the mold cavity.

9. A molded plastic article having a plastic substrate component with a front decorative surface having at least two surface areas of layers of different first and second materials having adjacent and connecting surface areas that are generally coplanar or continuous, including at the border line where the two surface layer materials meet, and, relative to the front surface, at least a portion of the first material is located on top of and overlaps at least a portion of the second.

10. An article according to claim 9 wherein the first surface material is an anodized aluminum and the second surface material is synthetic leather.

11. An article according to claim 9 wherein the first surface material is an anodized aluminum and the second surface material is microfiber synthetic suede.
